(19) United States
(12) Patent Application Publication
(10) Pub. No.: US 2014/0342809 A1
(43) Pub. Date: Nov. 20, 2014

(54) SYSTEMS AND METHODS FOR TRANSMITTING INFORMATION USING CAPACITIVE INK

(71) Applicant: Video Gaming Technologies, Inc., Franklin, TN (US)

(72) Inventor: Daniel William Milligan, Palmyra, VA (US)

(73) Assignee: Video Gaming Technologies, Inc., Franklin, TN (US)

(21) Appl. No.: 13/895,721

(22) Filed: May 16, 2013

(51) Int. Cl. G07F 17/32

(52) U.S. Cl. CPC G07F 17/3209
USPC 463/25

(57) ABSTRACT

An electronic gaming machine is provided. The electronic gaming machine includes a processor, a memory coupled to the processor, and a capacitive touch screen display. The memory comprises computer-executable instructions that, when executed by the processor, cause the electronic gaming machine to receive, through the capacitive touch screen display, an input code embodied in capacitive ink on a gaming item and compare the input code to at least one reference code. The computer-executable instructions additionally cause the electronic gaming machine to determine at least one action to be taken in response to receipt of the input code, based on the at least one reference code, and perform the at least one action.

### BACKGROUND

The embodiments described herein relate generally to gaming systems and, more particularly, to systems and methods that utilize capacitive ink to transmit information in gaming systems.

In at least some known casinos or other gaming environments, table games typically utilize one type of currency, such as chips, while electronic gaming machines use a different type of currency, such as electronic credits. Additionally, some known handheld devices that execute one or more games also use electronic credits as currency. At least some known electronic gaming machines include a card printer and card reader. The card printer and card reader enable credits to be transferred from a first electronic gaming machine to a second electronic gaming machine. However, no known systems or methods enable a single currency to be used at both casino tables and electronic gaming machines.

### BRIEF DESCRIPTION

In one aspect, an electronic gaming machine is provided. The electronic gaming machine includes a processor, a memory coupled to the processor, and a capacitive touch screen display. The memory comprises computer-executable instructions that, when executed by the processor, cause the electronic gaming machine to receive, through the capacitive touch screen display, an input code embodied in capacitive ink on a gaming item and compare the input code to at least one reference code. The computer-executable instructions additionally cause the electronic gaming machine to determine at least one action to be taken in response to receipt of the input code, based on the at least one reference code, and perform the at least one action.

In another aspect, a handheld gaming device is provided. The handheld gaming device includes a processor, a memory coupled to the processor, and a capacitive touch screen display. The memory comprises computer-executable instructions that, when executed by the processor, cause the handheld gaming device to receive, through the capacitive touch screen display, an input code embodied in capacitive ink on a gaming item and compare the input code to at least one reference code. The computer-executable instructions additionally cause the handheld gaming device to determine at least one action to be taken in response to receipt of the input code, based on the at least one reference code, and perform the at least one action.

In another aspect, a method for transmitting information using capacitive ink is provided. The method is implemented by a computing device including a processor, a memory coupled to the processor, and a capacitive touch screen display. The method includes receiving, by the computing device, through the capacitive touch screen display, an input code embodied in capacitive ink on a gaming item and comparing, by the computing device, the input code to at least one reference code. The method additionally includes determining, by the computing device, at least one action to be taken in response to receipt of the input code, based on the at least one reference code and performing, by the computing device, the at least one action.

In yet another aspect, a non-transitory computer-readable storage medium is provided. The computer-readable storage medium has embodied thereon computer-executable instructions. When executed by a computing device including a processor, a memory coupled to the processor, and a capacitive touch screen display, the computer-executable instructions cause the computing device to receive, through the capacitive touch screen display, an input code embodied in capacitive ink on a gaming item and compare the input code to at least one reference code. The computer-executable instructions additionally cause the computing device to determine at least one action to be taken in response to receipt of the input code, based on the at least one reference code and perform the at least one action.

### BRIEF DESCRIPTION OF THE DRAWINGS

FIG. 1 is a schematic diagram of an exemplary electronic gaming machine (EGM).

FIG. 2 is a schematic block diagram of an exemplary electrical architecture that may be used with the EGM shown in FIG. 1.

FIG. 3 is a schematic block diagram of an exemplary electrical architecture that may be used with a gaming table.

FIG. 4 is a schematic diagram of an exemplary handheld computing device.

FIG. 5 is a schematic block diagram of an exemplary electrical architecture that may be used with the handheld computing device of FIG. 4.

FIG. 6 is a schematic block diagram of an exemplary gaming system that includes a plurality of EGMs shown in FIG. 1, a plurality of gaming tables shown in FIG. 3, and a plurality of handheld computing devices shown in FIG. 4.

FIG. 7 is a schematic diagram of an exemplary voucher that includes capacitive ink printed thereon.

FIG. 8 is a schematic diagram of an exemplary gaming chip that includes capacitive ink printed thereon.

FIG. 9 is a flowchart of an exemplary method that may be implemented to transmit information with capacitive ink for use by the electronic gaming machine of FIG. 1, the gaming table of FIG. 3, and/or the handheld computing device of FIG. 4.

### DETAILED DESCRIPTION

Exemplary embodiments enable information pertaining to credits, promotions, and other features to be transmitted to and from computing devices having touch screen displays through capacitive ink. In the exemplary embodiment, the computing devices are electronic gaming machines, gaming tables, handheld computing devices (e.g., smart phones or tablets) and/or other devices that include touch screen displays. As described in more detail below, credits may be transferred between different games of chance locales, for example, a gaming table and an electronic gaming machine, using capacitive ink printed on a surface of a gaming item, for example, a voucher, a gaming chip, and/or a player tracking card. The locales may be separated by any distance. For example, the locales may be in the same building or, for example, in separate countries. Further, as described in more detail below, promotional vouchers having capacitive ink printed thereon may be used to activate unactivated game features or to apply promotional credits to a game when read by a computing device that includes a touch screen display or other component that is capable of reading the ink. Moreover, activities of a player (“a user”) using a voucher, a gaming chip, a player tracking card, or other gaming item having account-identifying information embodied thereon in capacitive ink may be tracked and/or monitored.

Exemplary technical effects of systems and methods described herein include at least one of: (a) receiving, through a capacitive touch screen display, an input code embodied in capacitive ink on a gaming item; (b) comparing the input code to at least one reference code; (c) determining at least one action to be taken in response to receipt of the input code, based on the at least one reference code; and (d) performing the at least one action.

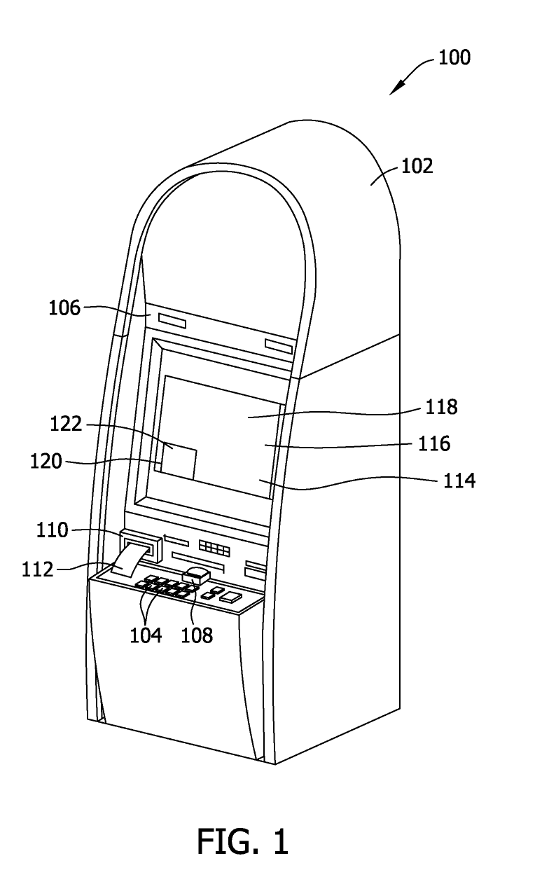

FIG. 1 is a schematic diagram of an exemplary electronic gaming machine 100 that enables a player to play one or more games of chance. Electronic gaming machine 100 is an example of a “computing device” for purposes of this description. Electronic gaming machine 100 may be any type of gaming machine, and may include, without limitation, different structures than those shown in FIG. 1. Moreover, electronic gaming machine 100 may employ different methods of operation than those described herein.

In the exemplary embodiment, electronic gaming machine 100 includes a cabinet 102 that houses a plurality of components, such as a gaming machine controller, peripheral devices, display devices, and player interaction devices. For example, in an exemplary embodiment, gaming machine 100 includes a plurality of switches and/or buttons 104 that are coupled to a front 106 of cabinet 102. Buttons 104 may be used to start play of a primary or secondary game. One button 104 may be a “Bet One” button that enables the player to place a bet or to increase a bet. Another button 104 may be a “Bet Max” button that enables the player to bet a maximum permitted wager. Yet another button 104 may be a “Cash Out” button that enables the player to receive a payment corresponding to a number of remaining credits.

In the exemplary embodiment, electronic gaming machine 100 also includes a coin acceptor 108 for accepting coins and/or tokens, and a bill acceptor 110 for accepting and/or validating cash bills, coupons, and/or vouchers 112. Bill acceptor 110 may also be capable of printing vouchers 112, as is described in greater detail below. Furthermore, in some embodiments, bill acceptor 110 includes a card reader or validator for use with credit cards, debit cards, identification cards, and/or smart cards. Cards accepted by bill acceptor 110 may include a magnetic strip and/or a preprogrammed microchip that includes a player's identification, credit totals, and any other relevant information that may be used. Moreover, in the exemplary embodiment, gaming machine 100 includes a touch screen display 114. Touch screen display 114 is mounted to cabinet 102, and includes a display device 116 and a touch-sensitive surface 118. Display device 116 may display a primary game and a secondary or bonus game. Display devices 116 may include, without limitation, a plasma display, a liquid crystal display (LCD), and/or a display based on light emitting diodes (LEDs), organic light emitting diodes (OLEDs), polymer light emitting diodes (PLEDs), and/or surface-conduction electron emitters (SEDs).

In an exemplary embodiment, display device 116 is used to display one or more game image, symbols and indicia such as a visual representation or exhibition of movement of an object such as a mechanical, virtual, or video reel, dynamic lighting, video images, and the like. In an alternative embodiment, display device 116 displays images and indicia using mechanical means. As described below, another type of computing device, such as handheld computing device, may perform similar functionality and may be configured to transfer a coupon or voucher to a user's casino playing account for downloading later, via another mechanism. Display device 116 may include a physical or simulated electromechanical device, such as one or more rotatable reels, to display a plurality of game or other suitable images, symbols, or indicia.

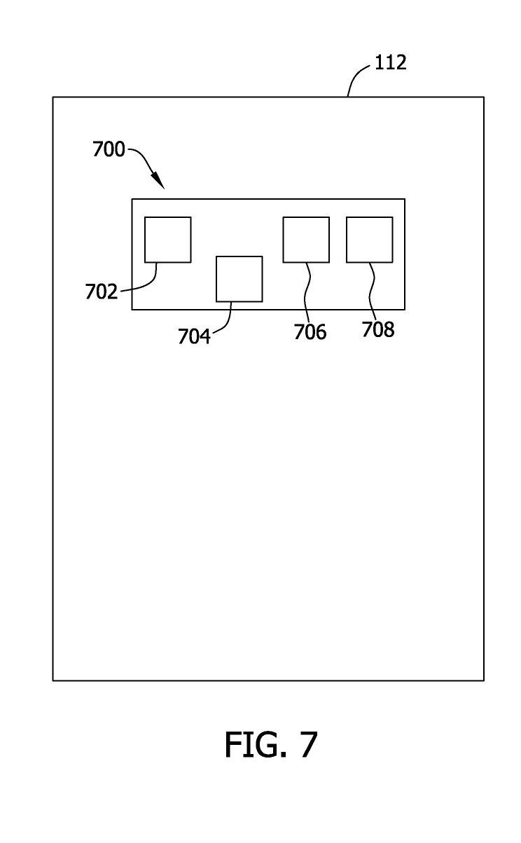

Touch-sensitive surface 118 is capable of sensing multiple points of contact (i.e., multi-touch) against touch-sensitive surface 118 through electrical capacitance. Accordingly, touch-sensitive surface 118 may sense contact by, for example, human fingers and/or capacitive ink printed on voucher 112. Additionally, touch screen display 114 may display a shape 120, for example a rectangle, around a region 122 to indicate to a user that voucher 112 should be held against region 122 of touch screen display 114 for electronic gaming machine 100 to receive an input code 700 (FIG. 7), as described herein.

The capacitive ink sensed by touch-sensitive surface 118 may be, for example, a conductive type or a dielectric type, depending on the particular implementation of touch-sensitive surface 118. In some implementations, touch-sensitive surface 118 includes capacitive sensors (not shown) that detect one or more conductive elements placed against touch-sensitive surface 118. In other implementations, the capacitive sensors detect one or more elements having a dielectric different from that of air. In some implementations, touch-sensitive surface 118 is based on projected capacitive touch (PCT) technology and includes an X-Y grid formed by etching a layer to form a grid pattern of electrodes, or by etching two separate, perpendicular layers of conductive material with parallel lines to form the grid. In such implementations, touch-sensitive surface 118 includes a capacitor at each intersection of each row and each column of the grid, and applies a voltage to the rows or columns of the grid. In such implementations, when one or more conductive elements are placed at locations near touch-sensitive surface 118, local electric fields are changed, thereby also changing the capacitance at corresponding points in the grid. The changes in capacitance may be measured to determine the locations of the elements.

In one embodiment, electronic gaming machine 100 randomly generates game outcomes using probability data. For example, each game outcome is associated with one or more probability values that are used by electronic gaming machine 100 to determine the game output to be displayed. Such a random calculation may be provided by a random number generator, such as a true random number generator, a pseudo-random number generator, or any other suitable randomization process.

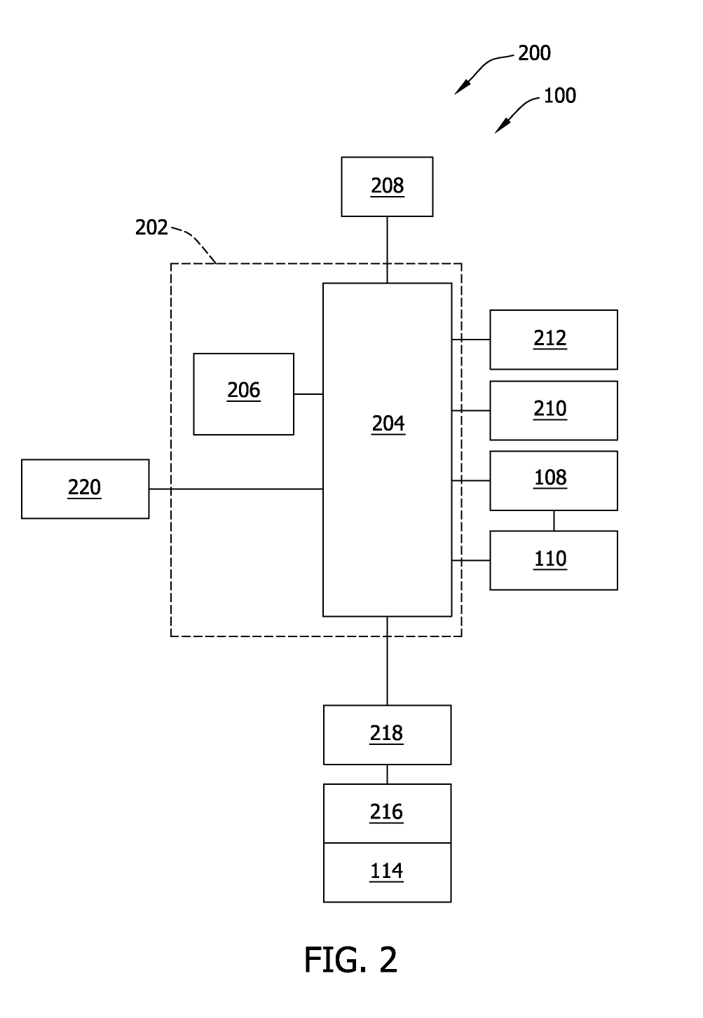

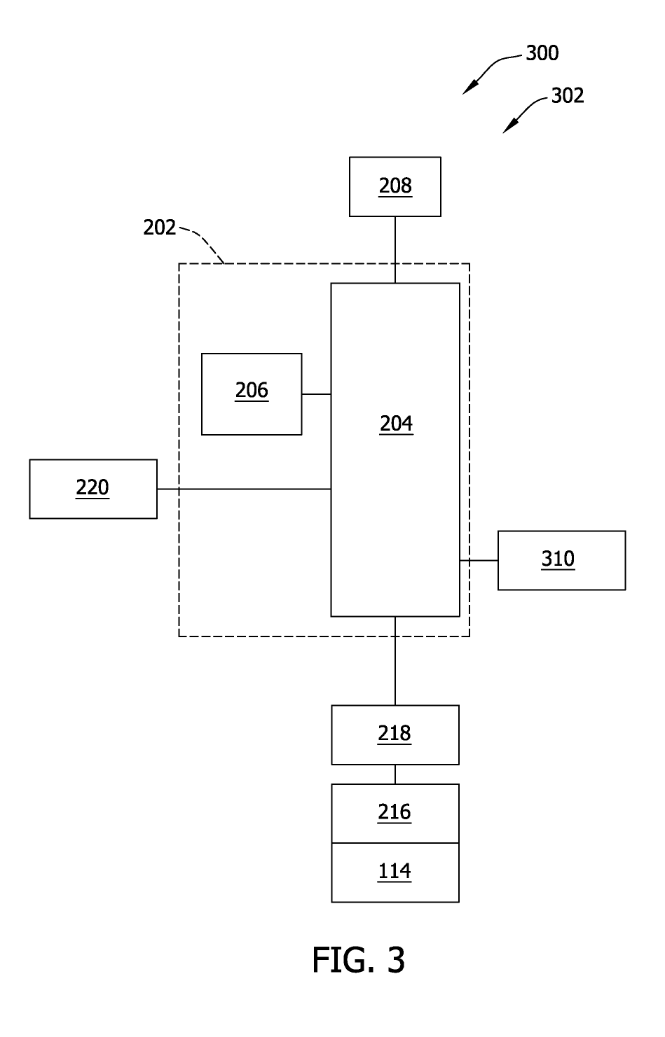

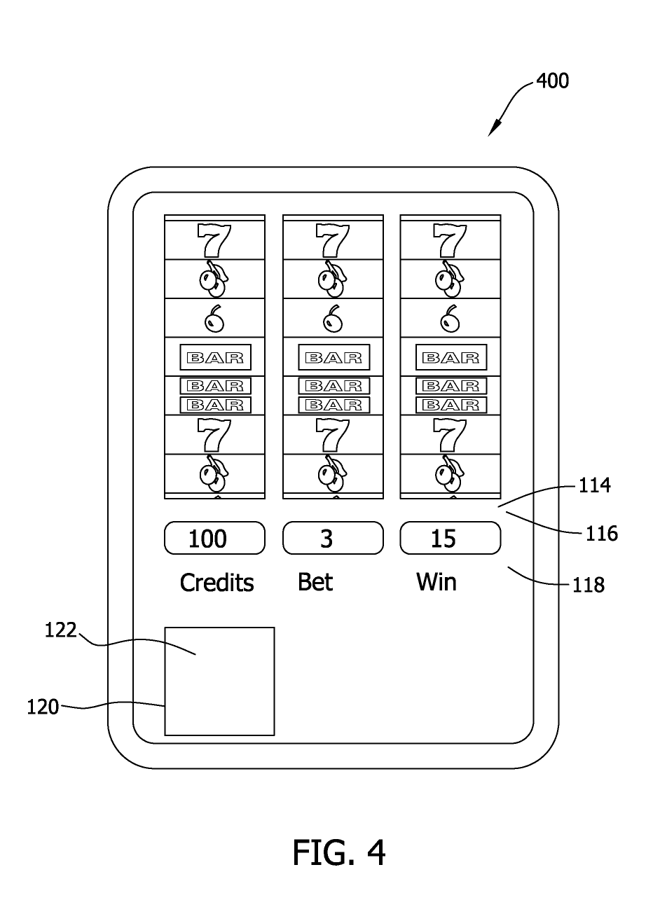

FIG. 2 is a schematic block diagram of an exemplary electrical architecture 200 that may be used with electronic gaming machine 100. In the exemplary embodiment, electronic gaming machine 100 includes a controller 202 having a processor 204 communicatively coupled a memory area 206. Moreover, in the exemplary embodiment, processor 204 and memory area 206 reside within cabinet 102 (shown in FIG. 1) and may be collectively referred to herein as a “computer” or “controller.” Controller 202 communicates with one or more other electronic gaming machines 100, gaming tables 300 (FIG. 3), handheld computing devices 400 (FIG. 4) and/or other suitable computing devices via a network interface 208. Processor 204 may be a microprocessor, a microcontroller-based platform, a suitable integrated circuit, and/or one or more application-specific integrated circuits (ASICs). However, the above examples are exemplary only, and thus are not intended to limit in any way the definition and/or meaning of the term “processor.”

Memory area 206 stores program code and instructions, executable by processor 204, for controlling gaming machine 100. For example, memory area 206 stores data such as image data, event data, player input data, random or pseudo-random number generation software, paytable data, and/or other information or applicable game rules that relate to game play on gaming machine 100. Moreover, memory area 206 may include one or more forms of memory. For example, memory area 206 can include random access memory (RAM), read-only memory (ROM), flash memory, and/or electrically erasable programmable read-only memory (EEPROM). In some embodiments, other suitable magnetic, optical, and/or semiconductor-based memory may be included in memory area 206 by itself or in combination.

In the exemplary embodiment, electronic gaming machine 100 includes a credit display 210, which displays a player's current number of credits, cash, account balance or the equivalent. Gaming machine 100 also includes a bet display 212 which displays a player's amount wagered. Credit display 210 and bet display 212 may be standalone displays independent of touch screen display 114, or credit display 210 and bet display 212 may be incorporated into touch screen display 114.

Moreover, in an exemplary embodiment, touch screen display 114 is controlled by controller 202. In some embodiments, touch screen display 114 is coupled with touch screen display controller 216. A video controller 218 is communicatively coupled to controller 202 and touch screen display controller 216 to enable a player to input game play decisions into gaming machine 100 via touch screen display 114. Furthermore, electronic gaming machine 100 includes one or more communication ports 220 that enable controller 202 to communicate with external peripheral devices (not shown) such as, but not limited to, external video sources, expansion buses, game or other displays, a SCSI port, or a key pad.

FIG. 3 is a schematic block diagram of an exemplary electrical architecture 302 that may be used with an exemplary gaming table 300. Gaming table 300 is another example of a “computing device” for purposes of this description. Gaming table 300 includes certain components that are also included in electronic gaming machine 100. Such components of gaming table 300 are labeled with the same reference numbers used in FIG. 2. More specifically, gaming table 300 includes touch screen display 114, controller 202, processor 204, memory area 206, network interface 208, touch screen display controller 216, video controller 218, and one or more communication ports 220. Additionally, gaming table 300 includes printer 310, which is configured to print vouchers 112 having information embodied in capacitive ink.

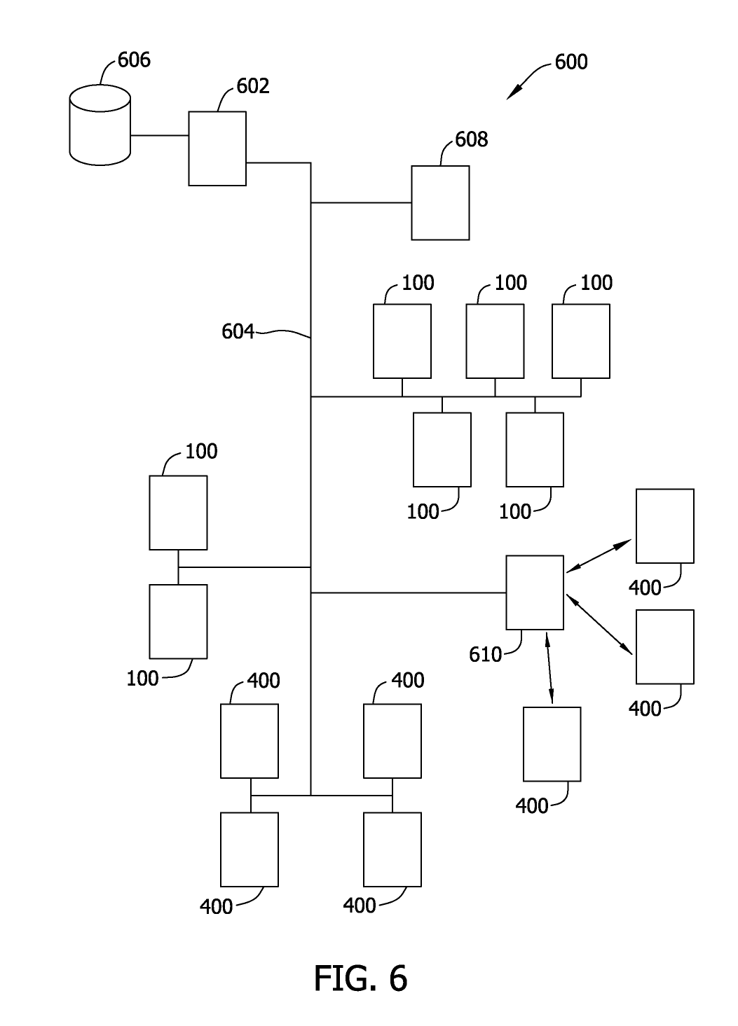

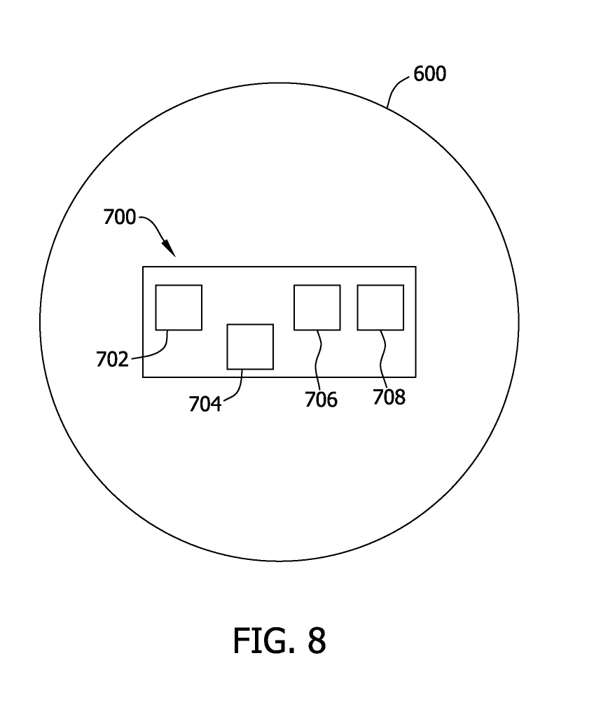

With reference to both electronic gaming machine 100 and gaming table 300, when a gaming item, for example voucher 112 or a gaming chip 800 (FIG. 8), having input code 700 (FIG. 7) embodied thereon in capacitive ink is placed into contact with touch screen display 114, controller 202 reads input code 700. Controller 202 then compares input code 700 to at least one reference code, which may be stored, for example, in memory area 206 and/or a remote memory area 606 (FIG. 6). Controller 202 then determines an action to be taken, based on the at least one reference code, and performs that action. Examples of such codes and actions are described in more detail below.

FIG. 4 is a schematic diagram of an exemplary handheld computing device (also referred to herein as a “handheld gaming device”) 400 that enables a player to play one or more games of chance. Handheld computing device 400 may be, for example, a tablet or smart phone. Handheld computing device 400 includes certain components that are also included in electronic gaming machine 100. Such components of handheld computing device are labeled with the same reference numbers used in FIG. 1.

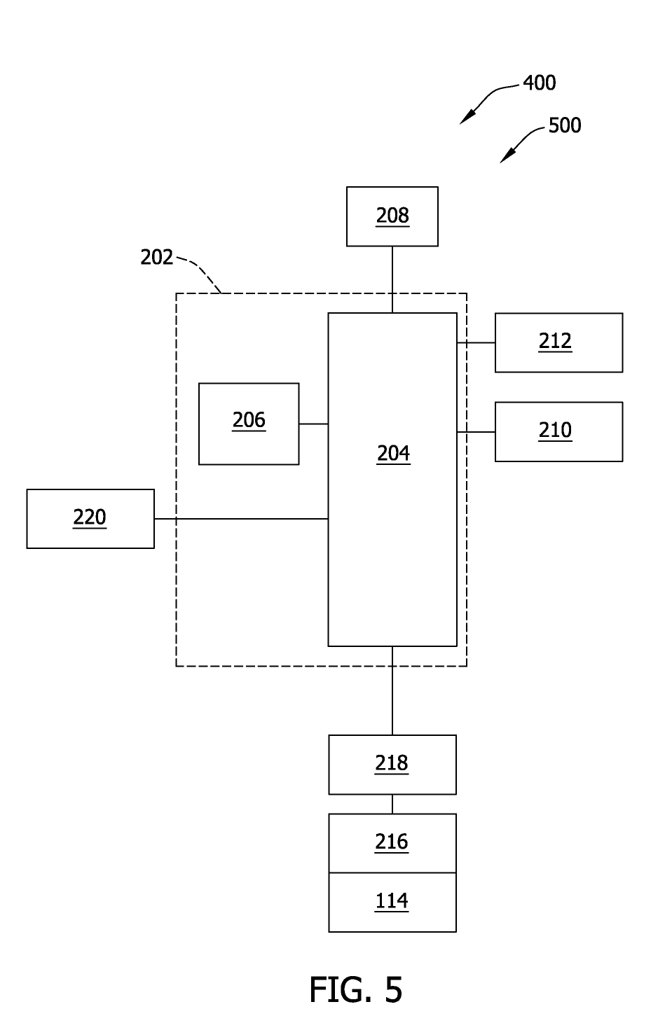

FIG. 5 is a schematic block diagram of an exemplary electrical architecture 500 that may be used with handheld computing device 400. Electrical architecture 500 includes certain components that are also included in electrical architecture 200. Such components of electrical architecture 500 are labeled with the same reference numbers used in FIG. 2.

FIG. 6 is a block schematic diagram of an exemplary gaming system 600 that includes a plurality of electronic gaming machines 100, gaming tables 300, and handheld computing devices 400. Each electronic gaming machine 100, gaming table 300, and handheld computing device 400 is coupled via network interface 208 to one or more servers, such as a gaming server 602, using a network 604. Network 604 may include, for example, a local area network (LAN) and/or a wide area network (WAN) (e.g., the Internet) and/or wireless networks of various types. Wireless hub 610 is coupled to network 604 and is in wireless communication with some handheld computing devices 400. In some implementations, at least one handheld computing device 400 may communicate with a printer 310 of a gaming table 300, a bill acceptor 110 of an electronic gaming machine 100, or other printer to print an input code in capacitive ink onto a voucher 112 or other gaming item. Gaming server 602 includes a processor (not shown) that facilitates data communication between each electronic gaming machine 100, each gaming table 300, each handheld computing device 400, and other components of gaming system 600. Such data is stored in, for example, a memory area 606, such as a database, that is coupled to gaming server 602.

As described above, electronic gaming machines 100 may include video bingo machines, video poker machines, video slot machines, and/or other similar gaming machines that implement alternative games. Moreover, gaming machines 100 may be terminal-based machines, wherein the actual games, including random number generation and/or outcome determination, are performed at gaming server 602. In such an embodiment, gaming machine 100 displays results of the game (e.g., game symbol combinations and/or prizes) via touch screen display 114 (shown in FIGS. 1 and 2). Handheld computing devices 400 perform similar functions.

Moreover, in the exemplary embodiment, gaming system 600 includes a configuration workstation 608 that includes a user interface that enables an administrator to set up and/or to modify portions of gaming system 600 and/or gaming server 602. Gaming server 602 may perform a plurality of functions including, for example, game outcome generation, player tracking functions, and/or accounting functions. However, in alternative embodiments, gaming system 600 may include a plurality of servers 602 that separately perform these functions and/or any suitable function for use in a network-based gaming system.

Moreover, in some embodiments, gaming server 602 tracks data of players using electronic gaming machines 100, gaming tables 300, and handheld computing devices 400 and also controls messages that appear on touch screen display 114 of electronic gaming machines 100, gaming tables 300, and handheld computing devices 400. For example, gaming server 602 can store physical characteristics of players, such as, but not limited to, the player age. Gaming server 602 can also store data related to the players and track players using player tracking identification, such as through a player card that has an input code 700 embodied thereon corresponding, for example, to a user account. Moreover, gaming server 602 can store information and data about the player such as loyalty points, player address, phone number, and/or any information that may be retrieved and transmitted to electronic gaming machines 100, gaming tables 300, and/or handheld computing devices 400. In some embodiments, gaming server 602 stores and tracks information such as, but not limited to, the average amount of wager played at gaming machines 100, gaming tables 300, and/or handheld computing devices 400. Moreover, gaming server 602 can track an average amount of wagers by the player, any funds the player may have in an account, and data relating to reportable events. Such data is associated with individual players and logged using a taxable accrual log.

FIG. 7 is a schematic diagram of voucher 112. Voucher 112 includes an input code 700 embodied in capacitive ink. More specifically, input code 700 is made up of a first portion 702 at a first position, a second portion 704 at a second position, a third portion 706 at a third position, and a fourth portion 708 at a fourth position. Each portion 702, 704, 706, and 708 is embodied in capacitive ink. The capacitive ink may be a conductive type or a dielectric type, depending on the particular implementation of touch-sensitive surface 118, as described above. The particular arrangement, including number, sizes, shapes, and positions, of portions 702, 704, 706, and 708 defines input code 700. While portions 702, 704, 706, and 708 are shaped as rectangles, in other embodiments, one or more of portions 702, 704, 706, and 708 may have a different shape. Additionally, in alternative embodiments, one or more of portions 702, 704, 706, and 708 is in a different position and/or has a different size. Furthermore, in some embodiments, input code 700 includes more or fewer than four portions.

When voucher 112 is placed into contact with touch screen display 114 of electronic gaming machine 100, gaming table 300, and/or handheld computing device 400, controller 202 of electronic gaming machine 100, gaming table 300, or handheld computing device 400 receives input code 700. In receiving input code 700, controller 202 may convert information about the arrangement of portions 702, 704, 706, and 708 into one or more numbers, letters, and/or other symbols. Controller 202 then compares input code 700 to one or more reference codes stored in memory area 206. Alternatively or additionally, controller 202 may compare input code 700 to one or more reference codes stored in memory area 606 (FIG. 6), through communication with gaming server 602.

In some embodiments, each reference code is associated with a user account identifier and/or an action. If input code 700 matches or includes a reference code associated with a user account, that particular user account is designated for subsequent action. Accordingly, a user may add or deduct credits from a user account maintained in memory area 206 and/or memory area 606. For example, a user may hold voucher 112 against touch screen display 114, such that input code 700 is received and compared to the one or more reference codes to designate the corresponding user account. Once the user account is designated, the user may add credits to the user account by inserting bills or a credit card into bill acceptor 110. Likewise, during the course of operating electronic gaming machine 100, playing a game at gaming table 300, or playing a game on handheld computing device 400, the user may win additional credits which may be added to the designated user account. Additionally, if the user loses credits during the course of operating electronic gaming machine 100, playing a game at gaming table 300, or playing a game on handheld computing device 400, the credits are deducted from the designated user account.

In some embodiments, input code 700 additionally includes an indication of an amount of credits to be added to a user account. For example, a business may give away a promotional voucher in which input code 700 corresponds with a reference code for adding a predetermined amount of credits to a user account. In the context of this disclosure, the promotional voucher is another example of a “gaming item”. In other embodiments, a promotional voucher may include an input code that corresponds to a promotional user account that has a predetermined amount of credits associated with it. In other embodiments, input code 700 may correspond to a reference code for activating an unactivated feature in a game. For example, upon determining that input code 700 corresponds to a reference code for a hidden game, a bonus round, a multiplier for credits awarded for winning a game, or designating the user as a jackpot winner, electronic gaming machine 100 activates the feature. In some embodiments, input code 700 is associated with a one-time only event or a limited use or multi-use feature. For example, the first 500 redemptions are validated, and any afterwards are not. In some embodiments, gaming server 602 determines when and/or how many times input code 700 can be redeemed and/or what features are activated.

FIG. 8 is a schematic diagram of an exemplary gaming chip 800 having capacitive ink printed thereon. Gaming chip includes input code 700 and first portion 702, second portion 704, third portion 706, and fourth portion 708 described above. As described with reference to FIGS. 1 and 7, the capacitive ink may be a conductive type or a dielectric type, depending on the particular implementation of touch-sensitive surface 118. Gaming chip 800 may be held against touch screen display 114 of electronic gaming machine 100, gaming table 300, or handheld computing device 400 such that a user account may be designated, as described above with reference to voucher 112. Accordingly, a user may play a game at gaming table 300 using a form of currency that is more customary to gaming tables than voucher 112. Credits are added to and/or deducted from the user account associated with input code 700 as described above with reference to voucher 112.

Given that gaming chip 800 includes input code 700, gaming chip 800 may also be used at electronic gaming machine 100 and/or handheld computing device 400. More generally, any computing device that includes touch screen display 114 may use voucher 112, gaming chip 800, and/or any other gaming item with input code 700 printed thereon in capacitive ink to operate as described with reference to electronic gaming machine 100, gaming table 300, and handheld computing device 400. Accordingly, rather than multiple forms of currency being used for gaming, a gaming establishment may standardize on a single form of currency having input codes 700 embodied thereon in capacitive ink. In some embodiments, one or more computing devices having touch screen display 114 facilitate the sale of non-gaming related items such as food, by reading input code 700, identifying a corresponding user account based on input code 700, and deducting credits from the user account to pay for the purchased item. Moreover, a user may leave a vicinity of the gaming establishment and continue playing games using the user account associated with input code 700 through handheld computing device 400. In such embodiments, network 604 includes a wide area network (WAN) to facilitate such activity.

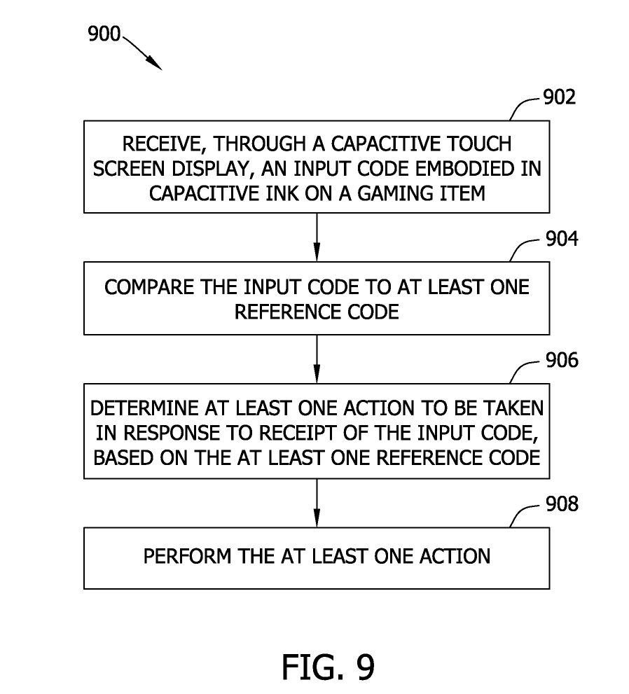

FIG. 9 is a flowchart that illustrates an exemplary method 900 for use in transmitting information with capacitive ink. Method 900 may be implemented for example by electronic gaming machine 100, gaming table 300, or handheld computing device 400. Alternatively or additionally, method 900 may be implemented by any other computing device having touch screen display 114. However, for simplicity, electronic gaming machine 100 is described performing method 900, as follows. Initially, electronic gaming machine 100 receives 902, through touch screen display 114, input code 700 from a gaming item (e.g., voucher 112) having capacitive ink embodied thereon. More specifically, and using voucher 112 as an example, a user presses voucher 112 against touch screen display 114 of electronic gaming machine 100 such that input code 700 is facing touch screen display 114. In some embodiments, electronic gaming device 100 designates a particular region of touch screen display 114 where voucher 112 should be placed. For example, electronic gaming machine 100 may cause touch screen display 114 to display shape 120 around region 122 on touch screen display 114 where voucher 112 should be placed. In some embodiments, as part of receiving input code 700, electronic gaming machine 100 converts information about the arrangement of portions 702, 704, 706, and 708 into one or more numbers, letters, and/or other symbols.

Next, electronic gaming machine 100 compares 904 received input code 700 to at least one reference code. For example, the at least one reference code may be stored in memory area 206 and/or memory area 606 in association with a user account and/or an action. In embodiments where the at least one reference code is stored in memory area 606, electronic gaming machine 100 transmits an instruction to gaming server 602 to retrieve the at least one reference code and associated user account or action from memory area 606. Each reference code is associated, in memory area 206 and/or memory area 606, with at least one user account (e.g., an account identifier) and/or at least one action.

Next, electronic gaming machine 100 determines 906 at least one action to be taken in response to receipt of input code 700, based on the at least one reference code, and performs 908 the at least one action. More specifically, if electronic gaming machine 100 determines that input code 700 matches or includes a reference code corresponding to a user account, electronic gaming machine 100 designates that user account for use in subsequent actions. Input code 700 may also include or match a reference code corresponding to one or more particular actions. The actions include, for example, adding and/or deducting credits from the user account, as described above. The subsequent actions may additionally or alternatively include adding promotional credits to an account and/or activating unactivated features, for example activating a hidden game, a bonus round, a multiplier for credits awarded for winning a game, or designating the user as a jackpot winner, as described above. As such actions are performed, electronic gaming machine 100 may notify gaming server 602 of the actions and gaming server 602 may store such actions in a log in memory area 606, for player tracking purposes. Additionally or alternatively, electronic gaming machine 100 may store a log of the actions in memory area 206.

Exemplary embodiments of systems and methods for transmitting information pertaining to credits, promotions, and other gaming features through capacitive ink to and from computing devices that include touch screen displays are described above in detail. The systems and methods are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A computer, computing device, controller, or server, such as those described herein (e.g., an electronic gaming machine, gaming table, and/or a gaming server), includes at least one processor or processing unit and a system memory. The computer, controller, or server typically has at least some form of computer-readable storage media. By way of example and not limitation, computer-readable media include computer-readable storage media and communication media. Computer-readable storage media include removable and non-removable devices implemented in any method or technology for storage of information such as computer-executable instructions, data structures, program modules, or other data. A computing device may be programmed to perform at least a portion of the operations described herein by, for example, encoding such operations as computer-executable instructions, providing the computer-executable instructions in a computer-readable storage media, and configuring the computing device to execute the instructions in the computer-readable storage media.

Although the present invention is described in connection with an exemplary gaming system environment, embodiments of the invention are operational with numerous other general purpose or special purpose gaming system environments or configurations. The gaming system environment is not intended to suggest any limitation as to the scope of use or functionality of any aspect of the invention. Moreover, the gaming system environment should not be interpreted as having any dependency or requirement relating to any one or combination of components illustrated in the exemplary operating environment.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “database” refers generally to any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic gaming machine comprising:
a processor;
a memory coupled to said processor; and
a capacitive touch screen display, wherein said memory comprises computer-executable instructions that, when executed by said processor, cause said electronic gaming machine to:
receive, through said capacitive touch screen display, an input code embodied in capacitive ink on a gaming item;
compare the input code to at least one reference code;
determine at least one action to be taken in response to receipt of the input code, based on the at least one reference code; and
perform the at least one action.

2. The electronic gaming machine of claim 1, wherein said memory further comprises computer-executable instructions such that the at least one action includes adding credit to a user account, subtracting credit from the user account, or applying credits stored in association with the user account to a game.

3. The electronic gaming machine of claim 1, wherein said memory further comprises computer-executable instructions that, when executed by said processor, cause said electronic gaming machine to store a log of the at least one action in association with a user account.

4. The electronic gaming machine of claim 1, wherein said memory further comprises computer-executable instructions such that the at least one action includes activating an unactivated feature in a game.

5. The electronic gaming machine of claim 1, further comprising a printer, wherein the input code is a first input code, wherein said electronic gaming machine is a first electronic gaming machine, wherein said touch screen display is a first touch screen display, and wherein said memory further comprises computer-executable instructions that, when executed by said processor, cause said first electronic gaming machine to print a second input code in capacitive ink on a voucher to be received by a second electronic gaming machine having a second touch screen display.

6. The electronic gaming machine of claim 1, wherein said memory further comprises computer-executable instructions that, when executed by said processor, cause said electronic gaming machine to display, through said capacitive touch screen display, a shape indicating a region of said touch screen display for receiving the input code.

7. The electronic gaming machine of claim 4, wherein said memory further comprises computer-executable instructions such that activating an unactivated feature in a game further comprises activating a bonus round.

8. The electronic gaming machine of claim 4, wherein said memory further comprises computer-executable instructions such that activating an unactivated feature in a game further comprises designating a user of the electronic gaming machine as a jackpot winner.

9. The electronic gaming machine of claim 4, wherein said memory further comprises computer-executable instructions such that activating an unactivated feature in a game further comprises activating a multiplier for awarded credits.

10. The electronic gaming machine of claim 4, wherein said memory further comprises computer-executable instructions such that activating an unactivated feature in a game further comprises activating a previously-hidden game.

11. A handheld gaming device comprising:
a processor;
a memory coupled to said processor; and
a capacitive touch screen display, wherein said memory comprises computer-executable instructions that, when executed by said processor, cause said handheld gaming device to:
receive, through said capacitive touch screen display, an input code embodied in capacitive ink on a gaming item;
compare the input code to at least one reference code;
determine at least one action to be taken in response to receipt of the input code, based on the at least one reference code; and
perform the at least one action.

12. The handheld gaming device of claim 11, wherein said memory further comprises computer-executable instructions such that the at least one action includes adding credit to a user account, subtracting credit from the user account, or applying credits stored in association with the user account to a game.

13. The handheld gaming device of claim 11, wherein said memory further comprises computer-executable instructions that, when executed by said processor, cause said handheld gaming device to store a log of the at least one action in association with a user account.

14. The handheld gaming device of claim 11, wherein said memory further comprises computer-executable instructions such that the at least one action includes activating an unactivated feature in a game.

15. The handheld gaming device of claim 11, wherein the handheld gaming device is communicatively coupled to a printer, wherein the input code is a first input code, wherein said touch screen display is a first touch screen display, and wherein said memory further comprises computer-executable instructions that, when executed by said processor, cause said handheld gaming device to cause the printer to print a second input code in capacitive ink on a voucher to be received by a computing device having a second touch screen display.

16. The handheld gaming device of claim 11, wherein said memory further comprises computer-executable instructions that, when executed by said processor, cause said handheld gaming device to display, through said capacitive touch screen display, a shape indicating a region of said touch screen display for receiving the input code.

17. The handheld gaming device of claim 14, wherein said memory further comprises computer-executable instructions such that activating an unactivated feature in a game further comprises activating a bonus round.

18. The handheld gaming device of claim 14, wherein said memory further comprises computer-executable instructions such that activating an unactivated feature in a game further comprises designating a user of the handheld gaming device as a jackpot winner.

19. The handheld gaming device of claim 14, wherein said memory further comprises computer-executable instructions such that activating an unactivated feature in a game further comprises activating a multiplier for awarded credits.

20. The handheld gaming device of claim 14, wherein said memory further comprises computer-executable instructions such that activating an unactivated feature in a game further comprises activating a previously-hidden game.

21. A method for transmitting information using capacitive ink, said method being implemented by a computing device including a processor, a memory coupled to the processor, and a capacitive touch screen display, said method comprising:
receiving, by the computing device, through the capacitive touch screen display, an input code embodied in capacitive ink on a gaming item;
comparing, by the computing device, the input code to at least one reference code;
determining, by the computing device, at least one action to be taken in response to receipt of the input code, based on the at least one reference code; and
performing, by the computing device, the at least one action.

22. The method of claim 21, wherein said performing the at least one action further comprises at least one of adding credit to a user account, subtracting credit from the user account, and applying credits stored in association with the user account to a game.

23. The method of claim 21, wherein said performing the at least one action further comprises activating an unactivated feature in a game.

24. The method of claim 21, wherein the computing device further comprises a printer, wherein the input code is a first input code, wherein the computing device is a first computing device, wherein the touch screen display is a first touch screen display, and said method further comprises printing a second input code in capacitive ink on a voucher to be received by a second computing device having a second touch screen display.

25. The method of claim 21, further comprising displaying, by the computing device through the capacitive touch screen display a shape indicating a region of the touch screen display for receiving the input code.

26. The method of claim 23, wherein said activating an unactivated feature in a game further comprises at least one of:
activating a bonus round;
designating a user of the computing device as a jackpot winner;
activating a multiplier for awarded credits; and
activating a previously-hidden game.

27. A non-transitory computer-readable storage medium having embodied thereon computer-executable instructions, wherein when executed by a computing device including a processor, a memory coupled to the processor, and a capacitive touch screen display, the computer-executable instructions cause the computing device to:
receive, through the capacitive touch screen display, an input code embodied in capacitive ink on a gaming item;
compare the input code to at least one reference code;
determine at least one action to be taken in response to receipt of the input code, based on the at least one reference code; and
perform the at least one action.

28. The non-transitory computer-readable storage medium of claim 27, further comprising computer-executable instructions such that performing the at least one action further comprises at least one of adding credit to a user account, subtracting credit from the user account, and applying credits stored in association with the user account to a game.

29. The non-transitory computer-readable storage medium of claim 27, further comprising computer-executable instructions such that performing the at least one action further comprises activating an unactivated feature in a game.

30. The non-transitory computer-readable storage medium of claim 29, further comprising computer-executable instructions such that activating an unactivated feature in a game further comprises at least one of:
activating a bonus round;
designating a user of the computing device as a jackpot winner;
activating a multiplier for awarded credits; and
activating a previously-hidden game.
